(19) United States
(12) Patent Application Publication
(10) Pub. No.: US 2012/0050252 A1
(43) Pub. Date: Mar. 1, 2012

(54) DISPLAY DEVICE

(76) Inventors: Hajime Akimoto, Kokubunji (JP); Masahisa Tsukahara, Fujisawa (JP); Kenta Kajiyama, Yotsukaido (JP)

(21) Appl. No.: 13/207,951

(22) Filed: Aug. 11, 2011

(30) Foreign Application Priority Data
Aug. 25, 2010 (JP) 2010-188584

(51) Int. Cl. G09G 5/00; G09G 3/36

(52) U.S. Cl. 345/212; 345/92

(57) ABSTRACT

An nMOS is used for a drive TFT and a display device is provided without being affected by variations in the threshold voltage of the drive TFT. A display device includes: a field-effect transistor that controls a drive current of a light emitting element; a first switch provided between a source of the field-effect transistor and an anode terminal of the light emitting element; a second switch provided between the source of the field-effect transistor and a signal line; a third switch provided between a drain of the field-effect transistor and a power supply line; a fourth switch provided between the drain and a gate of the field-effect transistor; a capacitor provided between the gate of the field-effect transistor and the anode terminal of the light emitting element; and a fifth switch provided between the anode terminal of the light emitting element and a predetermined voltage supply line.

### CLAIM OF PRIORITY

The present application claims priority from Japanese Patent Application JP 2010-188584 filed on Aug. 25, 2010, the content of which is hereby incorporated by reference into this application.

### BACKGROUND OF THE INVENTION

1. Field of the Invention

The present invention relates to display devices and particularly relates to a display device having self-luminous elements.

2. Description of the Related Art

In recent years, image display devices utilizing self-luminous elements called organic electro-luminescent (EL) elements have been put into practical use (hereinafter, the image display devices will be referred to as “organic EL display devices”). The organic EL elements are represented by organic light emitting diodes. Unlike liquid crystal display devices of the related art, organic EL display devices utilizing self-luminous elements do not need auxiliary lighting units such as backlights, achieving smaller thicknesses as well as high viewability and fast response speeds.

U.S. Pat. No. 6,229,506 and U.S. Patent Application No. 2003/0189535 disclose display devices utilizing such organic EL elements. FIG. 15 is an explanatory drawing showing the configuration of a pixel of the organic EL display device disclosed in U.S. Pat. No. 6,229,506. As shown in FIG. 15, a pixel 600 includes an organic EL element 601, a drive thin-film transistor (TFT) 603, and switches 602 and 605.

The anode of the organic EL element 601 is connected to a power supply Voled via the switch 602 and the drive TFT 603. The switch 605 is connected between the gate and source of the drive TFT. The gate of the drive TFT 603 is connected to a signal line 609 via a writing capacitor 607 and a switch 608 and is connected to the power supply Voled via a signal holding capacitor 606. In this configuration, the signal line 609 receives a signal corresponding to the gray scale value of the pixel 600.

An operation of the pixel 600 will be simply described below. First, the switch 602 and the switch 605 are turned on to apply a high voltage to the signal holding capacitor 606. After that, the switch 608 is turned on to input a predetermined voltage to the writing capacitor 607 from the signal line 609; meanwhile, the switch 602 is turned off to write the threshold voltage of the drive TFT 603 into the signal holding capacitor 606.

Next, a signal voltage is applied to the signal line 609, so that the signal voltage is divided into the writing capacitor 607 and the signal holding capacitor 606 and the divided voltage is additionally written into the signal holding capacitor 606. Thus the signal holding capacitor 606 stores the sum of the threshold voltage of the drive TFT 603 and the divided signal voltage. The drive TFT 603 is driven by the sum of the threshold voltage and the divided signal voltage, so that the drive TFT 603 can enable light emission of the organic EL element 601 without being affected by variations in threshold voltage.

According to U.S. Pat. No. 6,229,506, the display device with organic electro luminescence (EL) elements can be achieved without being affected by variations in the threshold value of the drive TFT 603 (see U.S. Pat. No. 6,229,506).

FIG. 16 is an explanatory drawing showing the configuration of a pixel of the display device disclosed in U.S. Patent Application No. 2003/0189535. As shown in FIG. 16, a pixel 620 of the display device includes a drive TFT 610 that is an nMOS transistor. The source of the drive TFT 610 is connected to the anode of an organic EL element 601.

Specifically, the anode of the organic EL element 601 included in the pixel 620 is connected to a power supply Voled via the drive TFT 610, and a capacitor 612 is connected between the gate and source of the drive TFT 610. The gate of the drive TFT 610 receives a signal through a TFT switch 613 and the source of the drive TFT is fed with a predetermined voltage through a TFT switch 611.

The operations of the pixel 620 will be simply described below. First, the TFT switches 613 and 611 are turned on, so that a potential difference between a signal voltage and the predetermined voltage is stored across the capacitor 612. After that, the TFT switches 613 and 611 are turned off, so that the potential difference stored across the capacitor 612 is held between the gate and source of the drive TFT 610. The drive TFT 610 causes the organic EL element 601 to emit light in response to a drive current corresponding to the signal voltage.

Generally, nMOS TFTs including electrons as conduction carriers have higher current drive capability than pMOS TFTs including holes as conduction carriers. Particularly, in the case of a large panel having a large number of pixels, drive TFTs with high current drive capability are desirable for light emission of organic EL elements. Thus nMOS drive TFTs are more desirable. Generally, the characteristics of nMOS TFTs have fewer dynamic distortions such as a hysteresis than those of pMOS TFTs. For this reason, nMOS drive TFTs are more desirable for higher image quality.

Generally, in a process of an organic EL element, a laminated structure is formed from a substrate. Thus in the case where a common electrode provided above the substrate includes an anode electrode such as an ITO, process damage may cause performance degradation. For this reason, a typical common electrode of an organic EL element is a cathode electrode and a drive TFT is typically connected to an anode electrode.

In the case where a drive TFT is an nMOS transistor, however, the source of the drive TFT has to be connected to the anode electrode of an organic EL element. Thus in this case, the pixel configuration of U.S. Pat. No. 6,229,506 is not applicable.

In the pixel configuration disclosed in U.S. Patent Application No. 2003/0189535, the drive TFT is an nMOS transistor and the source of the drive TFT is connected to the anode electrode of the organic EL element. Thus an nMOS can be used for the drive TFT.

However, the pixel of U.S. Patent Application No. 2003/0189535 cannot cancel variations in the threshold voltage of the drive TFT unlike the pixel of U.S. Pat. No. 6,229,506. Therefore, fixed noise caused by variations in the threshold voltage of the drive TFT may lead to serious image degradation.

### SUMMARY OF THE INVENTION

The present invention has been made in view of the above circumstances and provides a display device in which an nMOS is used for a drive TFT, the source of the drive TFT is connected to the anode electrode of an organic EL element, and a pixel configuration is not affected by variations in the threshold voltage of the drive TFT. The present invention is quite significant for achieving a large panel having a large number of pixels with high image quality in the near future.

A display device according to the present invention includes: plural pixels arranged in a matrix, each of the pixels having a light emitting element; a signal line that supplies a video signal voltage to each of the pixels according to a gray scale value; a power supply line that supplies light emission power to each of the light emitting elements; and a predetermined voltage supply line that supplies a predetermined voltage to each of the pixels. Furthermore, each of the pixels includes: a field-effect transistor that controls the drive current of the light emitting element; a first switch provided between the source of the field-effect transistor and an anode terminal of the light emitting element; a second switch provided between the source of the field-effect transistor and the signal line; a third switch provided between a drain of the field-effect transistor and the power supply line; a fourth switch provided between the drain and a gate of the field-effect transistor; a capacitor provided between the gate of the field-effect transistor and the anode terminal of the light emitting element; and a fifth switch provided between the anode terminal of the light emitting element and the predetermined voltage supply line.

In the display device of the present invention, the field-effect transistor may be an nMOS transistor.

In the display device of the present invention, the first to fifth switches may be nMOS transistors or pMOS transistors.

In the display device of the present invention, the first to fifth switches may be all nMOS transistors.

In the display device of the present invention, the second switch and the third switch may be connected to a common scanning line.

In the display device of the present invention, the first switch and the fifth switch may be connected to a common scanning line.

In the display device of the present invention, the first switch, the fifth switch, and the fourth switch may be connected to a common scanning line.

In the display device of the present invention, the first switch and a third switch included in the adjacent pixel may be connected to a common scanning line.

In the display device of the present invention, the fifth switch and the fourth switch may be connected to a common scanning line.

In the display device of the present invention, the predetermined voltage supply line may be a scanning line of the first switch.

In the display device of the present invention, the light emitting element may be an organic light emitting diode.

In the display device of the present invention, the field-effect transistor may be a TFT.

In the display device of the present invention, the TFT may be a polycrystalline Si semiconductor device.

In the display device of the present invention, the TFT may be a microcrystalline Si semiconductor device.

In the display device of the present invention, the TFT may be an amorphous semiconductor device.

In the display device of the present invention, the TFT may be an oxide semiconductor device.

An nMOS having high driving capability can be used for the drive TFT of the display device and variations in threshold voltage of the drive TFT can be canceled, enhancing image quality on a display screen.

### BRIEF DESCRIPTION OF THE DRAWINGS

FIG. 1 is an explanatory drawing showing a display device according to a first embodiment;

FIG. 2 is a schematic diagram of a TFT substrate shown in FIG. 1;

FIG. 3 is an explanatory drawing showing the configuration of a pixel of FIG. 2;

FIG. 4 is an explanatory drawing showing the outline of a driving state of the pixels over a display region;

FIG. 5 is a timing chart showing the operations of the switches of the pixel in each operation period according to the first embodiment;

FIG. 6 is an explanatory drawing showing the outline of a driving state of the pixels over the display region according to another example of the first embodiment;

FIG. 7 is an explanatory drawing showing a pixel configuration according to a second embodiment;

FIG. 8 is an explanatory drawing showing the outline of a driving state of pixels over a display region according to the second embodiment;

FIG. 9 is a timing chart showing the operations of the switches of the pixel in each operation period according to the second embodiment;

FIG. 10 is an explanatory drawing showing a pixel configuration according to a third embodiment;

FIG. 11 is an explanatory drawing showing the outline of a driving state of pixels over a display region according to the third embodiment;

FIG. 12 is a timing chart showing the operations of the switches of the pixel in each operation period according to the third embodiment;

FIG. 13 is an explanatory drawing showing a pixel configuration according to a fourth embodiment;

FIG. 14 is an explanatory drawing showing a TV image display device according to a fifth embodiment;

FIG. 15 is an explanatory drawing showing a pixel configuration according to the related art; and

FIG. 16 is an explanatory drawing showing a pixel configuration of according to the related art.

### DETAILED DESCRIPTION OF THE INVENTION

The following will describe embodiments of the present invention in accordance with the accompanying drawings. In the drawings, identical or similar elements are indicated by the same reference numerals and the same explanation thereof is omitted.

### First Embodiment

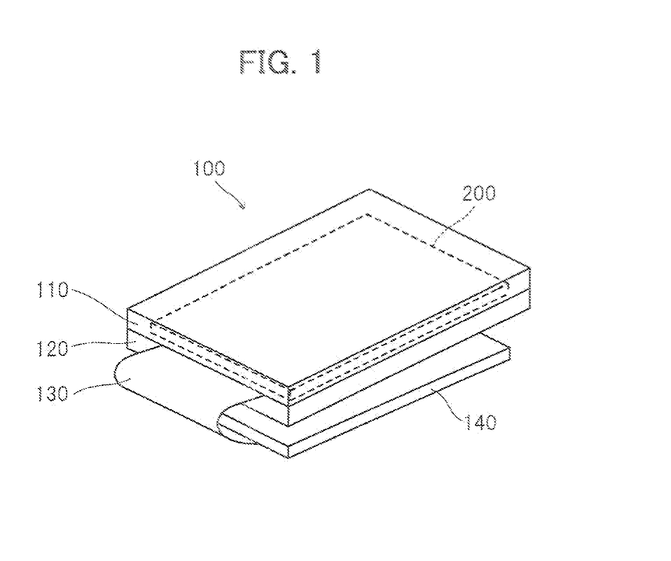

FIG. 1 is an explanatory drawing showing a display device according to a first embodiment of the present invention. As shown in FIG. 1, a display device 100 includes: an upper frame 110 and a lower frame 120 that fix a thin-film transistor (TFT) substrate 200 having a display panel such that the TFT substrate 200 is interposed between the upper and lower frames 110 and 120; a circuit board 140 having circuit elements for generating information to be displayed; and a flexible substrate 130 that transmits RGB information generated in the circuit board 140 to the TFT substrate 200.

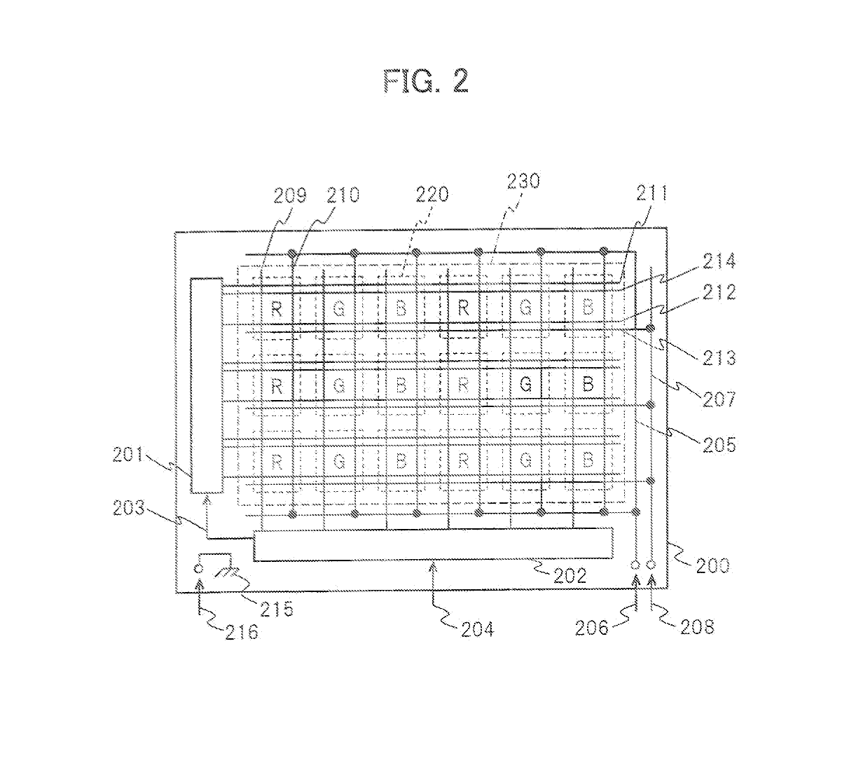

FIG. 2 is a schematic diagram of the TFT substrate shown in FIG. 1. As shown in FIG. 2, the TFT substrate 200 includes plural pixels 220, a pixel driving section 201, and a signal voltage generating section 202.

Each of the pixels 220 is connected to a pixel scanning line 211, a reset line 214, a light emission control line 212, and a potential line 213 in the horizontal direction of FIG. 2 The pixel scanning line 211, the reset line 214, and the light emission control line 212 are connected to the pixel driving section 201, and the potential line 213 is connected to a potential wire 207.

Moreover, each of the pixels 220 is connected to a signal line 209 and a power supply line 210 in the vertical direction of FIG. 2. The signal line 209 is connected to the signal voltage generating section 202 and the power supply line 210 is connected to a power supply wire 205 at both ends.

For simplification of FIG. 2, only the two pixel units are illustrated in the horizontal direction and only the three pixel units are illustrated in the vertical direction. The number of pixels may be optionally changed. In the present embodiment, one unit includes, for example, the three pixels 220 having luminescent colors of red (R), green (G), and blue (B).

The pixel driving section 201 is connected to the signal voltage generating section 202 via a control signal line 203.

To the signal voltage generating section 202, an external control signal line 204 is connected from the outside of the TFT substrate 200. The power supply wire 205 is connected to an external power supply wire 206, and the potential wire 207 is connected to an external potential wire 208.

A common electrode 215, to which the cathode of an organic EL element 301 is grounded, is connected to an external ground wire 216.

These circuits are disposed on, for example, the TFT substrate 200 that is a glass substrate. The signal voltage generating section 202 is mounted as a semiconductor chip and the pixel driving section 201 is configured as a polycrystalline Si-TFT like the pixel 220 on the TFT substrate 200. The polycrystalline Si-TFT may be replaced with a TFT of microcrystalline Si, amorphous Si, or an oxide semiconductor.

The following will describe the outline of the operations of the display device 100 configured thus.

In response to a control signal inputted from the external control signal line 204, the signal voltage generating section 202 controls the pixel driving section 201 through the control signal line 203. After that, the signal voltage generating section 202 outputs a signal voltage to the signal lines 209 according to a gray scale value at which light is to be emitted from the pixels 220.

At this point, as will be described later, the pixel driving section 201 controls predetermined signals inputted to the pixel driving lines 211, the reset lines 214, and the light emission control lines 212 in synchronization with the outputted signal voltage, and drives the pixels 220.

To the power supply lines 210 and the power supply wire 205, a power supply voltage is supplied through the external power supply wire 206. To the potential lines 213 and the potential wire 207, a predetermined voltage is supplied through the external potential wire 208. To the common electrode 215, a ground voltage is supplied through the external ground wire 216. With this configuration, the pixels 220 of the display device 100 display images in response to the control signal.

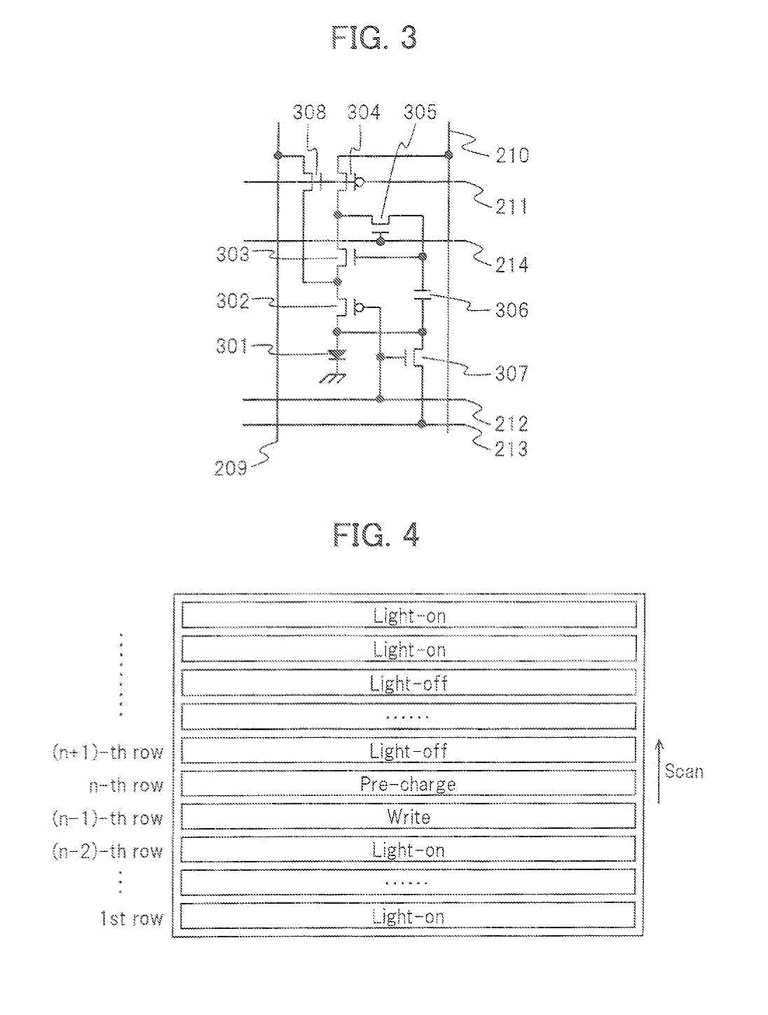

The configuration of the pixel 220 in FIG. 2 will be described below. FIG. 3 is an explanatory drawing showing the configuration of the pixel of FIG. 2.

As shown in FIG. 3, the pixel 220 has the organic EL element 301. The cathode of the organic EL element 301 is grounded to the common electrode 215 and the anode of the organic EL element 301 is connected to the source of a drive TFT 303 via a pMOS switch 302. Furthermore, the anode of the organic EL element 301 is connected to the potential line 213, which has been fed with a predetermined voltage, via an nMOS switch 307. The drive TFT 303 is a field-effect transistor that is formed of, for example, a polycrystalline Si semiconductor device, a microcrystalline Si semiconductor device, an amorphous semiconductor device, or an oxide semiconductor device.

The source of the drive TFT 303 is connected to the signal line 209 via the nMOS switch 308. The drain of the drive TFT 303 is connected to the power supply line 210 via the pMOS switch 304 and is connected to the gate of the drive TFT 303 via the nMOS switch 305. The gate of the drive TFT 303 is connected to the anode of the organic EL element 301 via a holding capacitor 306.

An nMOS switch 308 and a pMOS switch 304 are connected to the pixel scanning line 211, and the nMOS switch 305 is connected to the reset line 214. The pMOS switch 302 and the nMOS switch 307 are connected to the light emission control line 212.

For example, the switches and the drive TFT 303 are configured as polycrystalline Si-TFTs that are varied in size and are identical in basic structure. The pixels 220 are provided on the glass substrate.

Referring to FIG. 4, the operations of the pixels 220 will be described below. FIG. 4 is an explanatory drawing showing the outline of a driving state of the pixels over a display region. Specifically, FIG. 4 shows a driving state of the pixels 220 at some point in a horizontal scanning period.

As described above, the plural pixels 220 are arranged in a matrix in a display region 230 of the TFT substrate 200. The rows of the pixels 220 arranged in the matrix are sequentially scanned from below to above in FIG. 4.

Specifically, as shown in FIG. 4, the n-th pixel row performs a pre-charge operation, which will be described later, in a horizontal scanning period; meanwhile, the (n−1)-th pixel row performs a writing operation and the (n−2)-th and previous pixel rows perform a light-on operation.

The light-on operation is performed by consecutive pixel rows and subsequent consecutive pixel rows perform a light-off operation until the subsequent pre-charge operation.

In the subsequent horizontal scanning period, scanning proceeds to the subsequent row. Specifically, the n-th pixel row performs a writing operation and the (n−1)-th and previous pixel rows perform a light-on operation. The same operation is repeated thereafter.

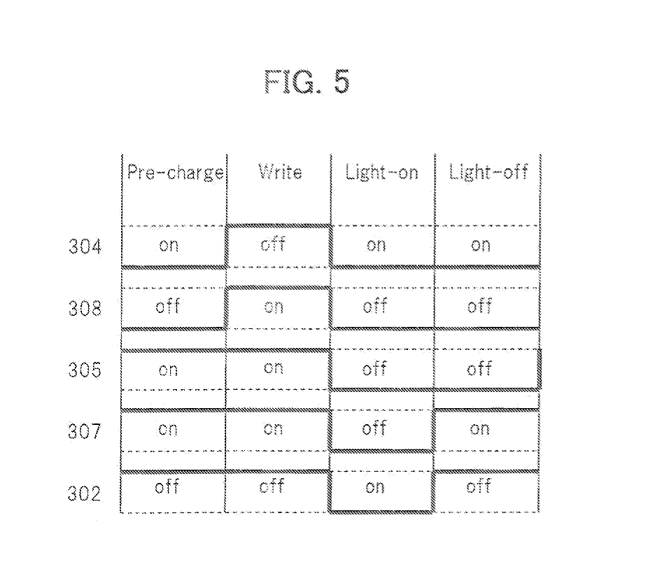

FIG. 5 is a timing chart showing the operations of the switches of the pixel in each operation period. In 5, “on” represents the turning-on of the switches and “off” represents the turning-off of the switches. Rectangular operation waveforms indicate variation in the gate voltages of the switches. As a matter of course, the nMOS switch is turned on at a high gate voltage and the pMOS switch is turned on at a low gate voltage.

First, in a pre-charge operation period, the pMOS switch 304 is turned on the nMOS switch 308 is turned off, the nMOS switch 305 is turned on, the nMOS switch 307 is turned on, and the pMOS switch 302 is turned off.

Thus the voltage of the power supply line 210 is inputted to one end of the holding capacitor 306 through the pMOS switch 304 and the nMOS switch 305; meanwhile, the predetermined voltage (e.g., 0 V) inputted to the potential line 213 is inputted to the other end of the holding capacitor 306.

Thus a voltage across the holding capacitor 306 is pre-charged to the voltage of the power supply line 210 and the predetermined voltage (e.g., 0 V) inputted to the potential line 213.

The predetermined voltage inputted to the potential line 213 is not higher than the light emission starting voltage of the organic EL element 301. Thus unlike in the display device of U.S. Pat. No. 6,229,506, it is possible to avoid erroneous light emission of the organic EL element 301 during the pre-charge operation period, achieving a higher contrast ratio on a display screen. The present embodiment is not limited to the above configuration. The predetermined voltage inputted to the potential line 213 may be any voltage not higher than the voltage of the power supply line 210.

In the subsequent writing operation period, the pMOS switch 304 is turned off, the nMOS switch 308 is turned on, the nMOS switch 305 is turned on, the nMOS switch 307 is turned on, and the pMOS switch 302 is turned off.

Thus the signal voltage written in the signal line 209 is inputted to the source of the drive TFT 303 through the nMOS switch 308.

As described above, the drain and gate of the drive TFT 303 are both connected to one end of the holding capacitor 306, in which the voltage of the power supply line 210 has been pre-charged, via the nMOS switch 305. Thus when the voltage across the holding capacitor 306 decreases to (signal voltage+Vth (the threshold voltage of the drive TFT 303)−(the predetermined voltage inputted to the potential line 213)), the drive TFT 303 is turned off to hold the voltage.

In the subsequent light-on operation period, the pMOS switch 304 is turned on, the nMOS Switch 308 is turned off, the nMOS switch 305 is turned off, the nMOS switch 307 is turned off, and the pMOS switch 302 is turned on.

Thus the drain of the drive TFT 303 is fed with the power supply voltage of the power supply line 210. Between the gate and source of the drive TFT 303, the voltage of (signal voltage+Vth (the threshold voltage of the drive TFT 303)−(the predetermined voltage inputted to the potential line 213)) is inputted which has been held across the holding capacitor 306. The source of the drive TFT 303 is connected to the organic EL element 301.

Thus the Organic EL element 301 emits light with a grayscale luminance corresponding to a current depending upon the signal voltage written in the holding capacitor 306. At this point, the organic EL element 301 is not: affected by variations in Vth (threshold voltage) of the drive TFT 303. This is because in the writing operation period, the holding capacitor holds (signal voltage+Vth (the threshold voltage of the drive TFT 303)−(the predetermined voltage inputted to the potential line 213)) and the drive TFT 303 is driven by a potential difference held the holding capacitor.

In the above explanation, the predetermined voltage inputted to the potential line 213 may be used for adjusting the offset voltage of the signal voltage. Furthermore, as described above, the light-on operation periods are consecutively provided over the predetermined horizontal scanning periods.

In the subsequent light-off operation period, the pMOS switch 304 is turned on, the nMOS switch 308 is turned off, the nMOS switch 305 is kept turned off, the nMOS switch 307 is turned on, and the pMOS switch 302 is turned off.

Hence, the anode of the organic EL element 301 is disconnected from the drive TFT 303 but is connected to the potential line 213, so that the light emission of the organic EL element 301 is forced to stop. Specifically, the anode of the organic EL element 301 is net simply opened but is set at the predetermined voltage (e.g., 0 V) inputted to the potential line 213, thereby controlling light emission with high accuracy. As described above, the consecutive light-off operation periods are optionally provided over the predetermined horizontal scanning periods. The anode of the organic EL element 301 may be simply opened.

As described above, the light-off operation periods are provided after the light-on operation periods and the ratio of the periods is optionally controlled. Thus unlike in the display devices of U.S. Pat. No. 6,229,506 and U.S. Patent Application No. 2003/0189535, the luminance of the display device 100 can be optionally adjusted while keeping a dynamic range of luminance. Specifically, for example, the luminance of the display device can be optionally adjusted from 500 (cd/m2) to 5 (cd/m2) while keeping the dynamic range of luminance at one million to one.

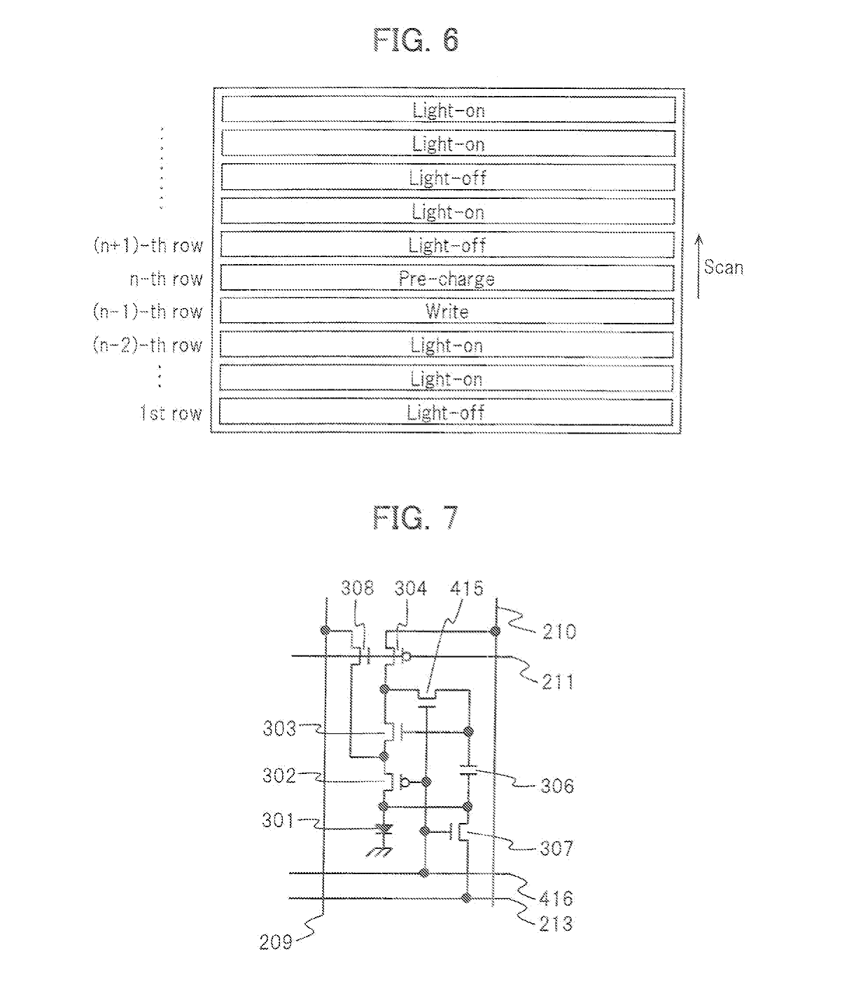

The display device 100 may be driven as shown in FIG. 6. FIG. 6 is an explanatory drawing showing the outline of a driving state of the pixels over the display region according to another example.

The driving method of FIG. 6 is different from that of FIG. 4 in that the light-on operation is dispersed in a plurality of periods and the light-off operation periods are provided between the light-on operation periods. In the driving method of FIG. 6, the dispersed light-on operation leads to a lower moving image resolution but reduces flicker on the screen. The driving methods of FIGS. 4 and 6 are respectively suitable for displaying moving images and static images. Thus the driving methods may be optionally used depending upon tee purpose of the display device. Alternatively, the light-off operation periods may not be provided.

As described above, according to the present embodiment, an nMOS having high driving capability can be used for the drive TFT, achieving a large panel having a large number of pixels. Moreover, the characteristics of an nMOS TFT have few dynamic distortions such as hysteresis, achieving high image quality. Furthermore, the organic EL element may have a cathode electrode structure with higher performance and reliability.

Additionally, it is possible to cancel variations in the threshold voltage of the drive TFT, thereby preventing fixed noise caused by variations in the threshold voltage of the drive TFT from leading to serious image degradation. These effects can be obtained without complicated pixel circuits.

The present invention is not Limited to the present embodiment and various modifications can be made. For example, the configuration of the present embodiment can be replaced with substantially the same configuration, a configuration achieving substantially the same effect, or a configuration attaining the same purpose as the configuration of the present embodiment.

### Second Embodiment

FIG. 7 is an explanatory drawing showing a pixel configuration according to a second embodiment of the present invention. As shown in FIG. 7, the second embodiment is different from the first embodiment in that a reset line 214 is not provided and an nMOS switch 415 is connected with a pMOS switch 302 and an nMOS switch 307 to a light emission control line 416. Other points of the second embodiment are similar to those of the first embodiment and the explanation thereof is omitted.

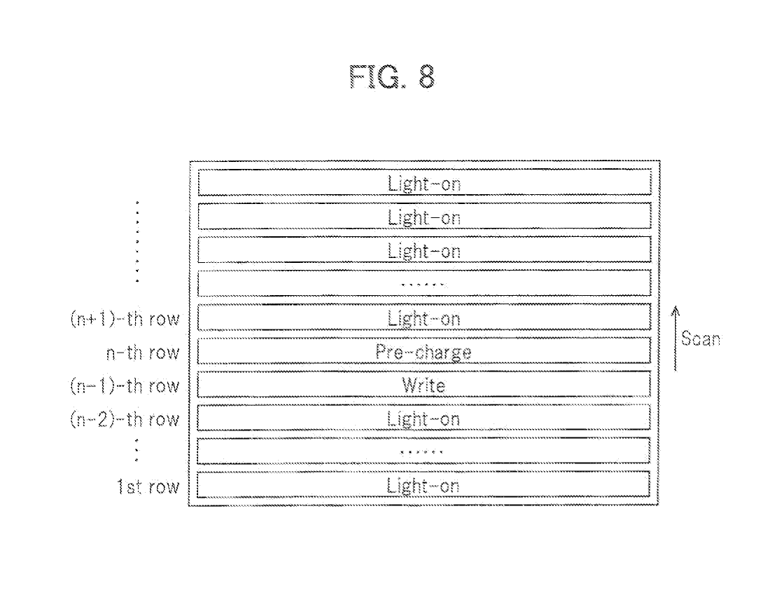

Referring to FIG. 8, the operations of a pixel 220 will be described below. FIG. 8 is an explanatory drawing showing the outline of a driving state of the pixels over a display region according to the present embodiment. Specifically, FIG. 8 shows a driving state of the pixels 220 at some point in a horizontal scanning period. As in the first embodiment, the rows of the pixels 220 are sequentially scanned from below to above. The present embodiment is different from the first embodiment in that a light-off operation period is not provided. Other points of the second embodiment are similar to those of the first embodiment and the explanation thereof is omitted.

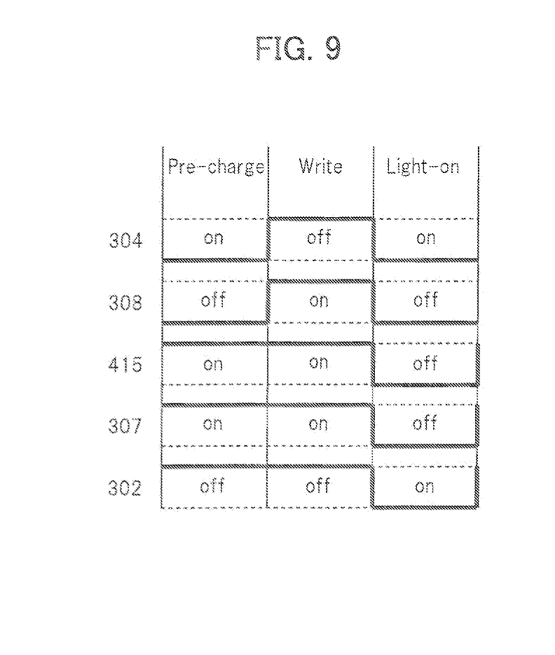

FIG. 9 is a timing chart showing the operations of the switches of the pixel in each operation period. In FIG. 9, “on” represents the turning-on of the switches and “off” represents the turning-off of the switches. Rectangular operation waveforms indicate variation in the gate voltages of the switches. The nMOS switch is turned on at a high gate voltage and the pMOS switch is turned on at a low gate voltage.

As described above, the light-off operation period is not provided for the operations of the pixel 220 in the present embodiment. In other words, as shown in FIG. 9, only a pre-charge operation period, a writing operation period, and a light-on operation period are provided. The timing chart of the switches of the pixel 220 in the pre-charge operation period, the writing operation period, and the light-on operation period is similar to that of the first embodiment and thus the explanation thereof is omitted.

As in the first embodiment, according to the present embodiment, an nMOS having high driving capability can be used for a drive TFT, achieving a large panel having a large number of pixels. Moreover, the characteristics of an nMOS TFT have few dynamic distortions such as a hysteresis, achieving high image quality. Furthermore, an organic EL element may have a cathode electrode structure with higher performance and reliability.

Additionally, it is possible to cancel variations in the threshold voltage of the drive TFT, thereby preventing fixed noise caused by variations in the threshold voltage of the drive TFT from leading to serious image degradation. These effects can be obtained without complicated pixel circuits.

Furthermore, as shown in FIG. 9, the nMOS switch 415 and the nMOS switch 307 in the same pixel 220 simultaneously operate in the present embodiment, so that the reset line 214 can be omitted. Consequently, the layout of the pixels 220 and the pixel driving section 201 can be further simplified.

The present invention is not limited to the present embodiment and various modifications can be made. For example, the configuration of the present embodiment can be replaced with substantially the same configuration, a configuration achieving substantially the same effect, or a configuration attaining the same purpose as the configuration of the present embodiment.

For example, in the present embodiment, the light-off operation period is not provided. As in FIG. 6 of the first embodiment, The light-off operation period may be provided as a continuous term as in FIG. 6 of the first embodiment. In the present embodiment, however, the nMOS switch 415 and the nMOS switch 307 simultaneously operate, so chat the nMOS switch 415 is turned on in the light-off operation periods.

Thus once the light-off operation period is provided, the light-on operation period cannot succeed thereafter. Therefore, the pixel rows cannot be driven as in FIG. 6 of the first embodiment, that is, the light-on operation can not be dispersed in a plurality of periods and the light-off period cannot be provided between two light-on operation periods as in the first embodiment.

However, when a continuous light-off operation period is provided after the light-on operation period and the ratio of the periods is optionally controlled, the luminance of the display device can be optionally adjusted while keeping a dynamic range of luminance, unlike in the display devices of U.S. Pat. No. 6,229,506 and U.S. Patent Application No. 2003/0189535. Specifically, for example, the luminance of the display device 100 can be optionally adjusted from 500 cd/m2) to 5 (cd/m2) while keeping the dynamic range of luminance at one million to one.

### Third Embodiment

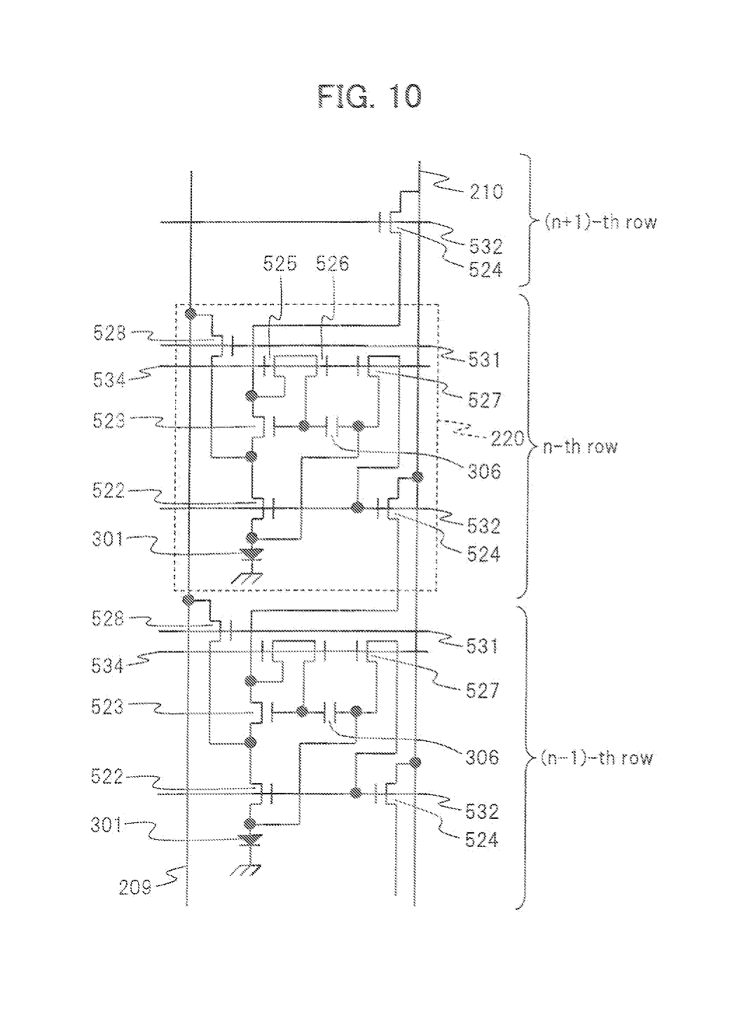

FIG. 10 is are explanatory drawing showing a pixel configuration according to a third embodiment. The present embodiment is different from the first embodiment mainly in that a gate wire is shared between switches provided in a pixel 220. Other points are similar to those of the first embodiment, and the explanation thereof is omitted.

As shown in FIG. 10, the cathode of an organic EL element 301 is grounded to a common electrode and the anode of the organic EL element 301 is connected to the source of a drive TFT 523 via an nMOS switch 522.

The source of the drive TFT 523 is also connected to a signal line 209 via an nMOS switch 528. The drain of the drive TFT 523 connected to a power supply line 210 via an nMOS switch 524 of an adjacent pixel 220. The drain of the drive TFT 523 is connected to the gate of the drive TFT 523 via nMOS switches 525 and 526.

The gate of the drive TFT 523 is connected to the anode of the organic EL element 301 via a holding capacitor 306. The anode of the organic EL element 301 is connected to a light emission control line 532, which has been fed with a predetermined voltage, via an nMOS switch 527.

The nMOS switch 528 is connected to a pixel scanning line 531. The nMOS switch 527 and the nMOS switches 525 and 526 are connected to a reset line 534. The nMOS switch 522 and the nMOS switch 524 of the adjacent pixel 220 are connected to the light emission control line 532. For example, the switches and the drive TFT 523 are configured as polycrystalline Si-TFTs that are varied in size and are identical in basic structure. The pixels 220 are provided on a glass substrate.

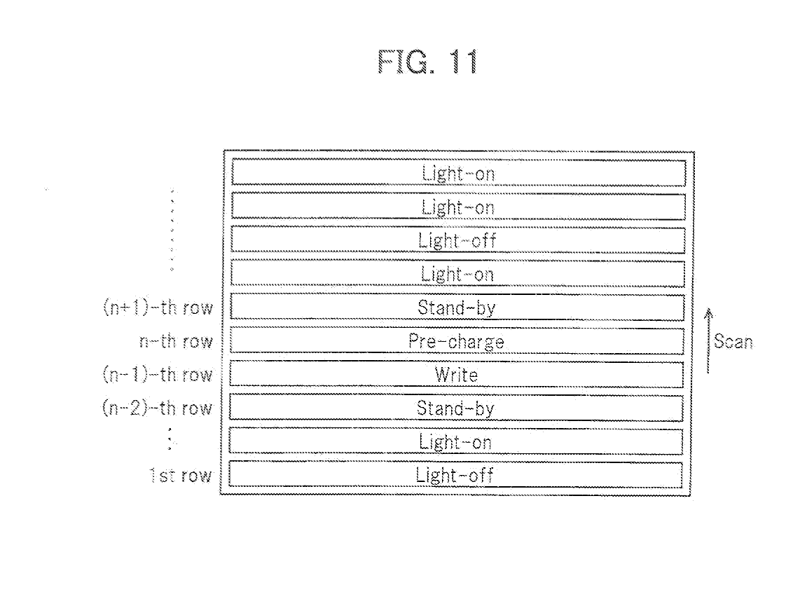

Referring to FIG. 11, the operations of the pixels 220 will be described below. FIG. 11 is an explanatory drawing showing the outline of a driving state of the pixels over a display region. Specifically, FIG. 11 shows a driving state of the pixels 220 at some point in a horizontal scanning period. As in the first embodiment, the rows of the pixels 220 are sequentially scanned from below to above. Other points are similar to those of the first embodiment and thus the explanation thereof is omitted.

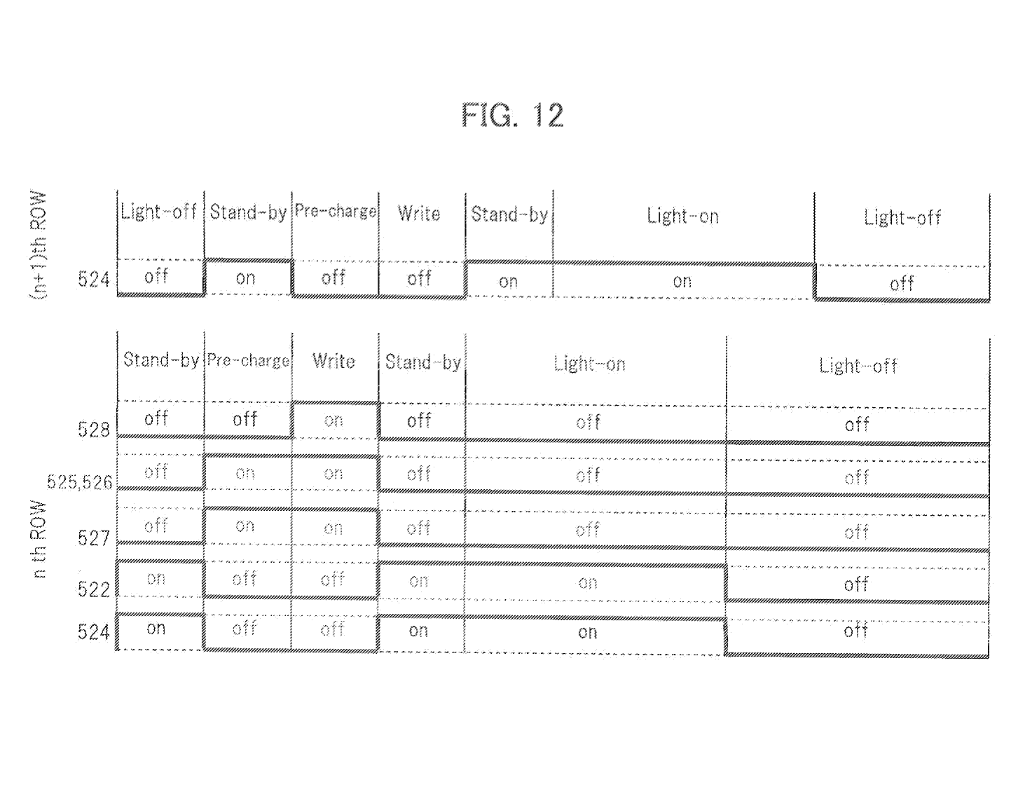

FIG. 12 is a timing chart showing the operations of the switches of the pixel in each operation period. In FIG. 12, “on” represents the turning-on of the switches and “off” represents the turning-off of the switches. Rectangular operation waveforms indicate variation in the gate voltages of the switches. Moreover, the nMOS switch is turned on at a high gate voltage and the pMOS switch is turned on at a low gate voltage. In the following explanation, the pixel 220 of the n-th row will be mainly discussed. Specifically, regarding operations in periods such as a stand-by operation period, the operations of the pixel 220 of the n-th row will be mainly discussed below. In FIG. 12, the ((n+1)-th) row corresponds to the (n+1)-th pixel row and the (n-th) row corresponds to the n-th pixel row.

In the stand-by operation period before a pre-charge operation period, the nMOS switch 528 is turned off, the nMOS switches 525 and 526 are turned off, the nMOS switch 527 is turned off, and the nMOS switch 522 is turned on.

At this point, the nMOS switch 524 in the pixel 220 of the (n+1)-th row is turned off (corresponding to a light-off operation period) and the nMOS switch 524 in the pixel 220 of the n-th row is turned on. Hence, the nMOS switch 522 is turned on but the nMOS switch 524 in the pixel 220 of the (n+1)-th row is turned off, so that power is not supplied to the drive TFT 523 and the organic EL element 301 does not emit light.

The stand-by operation period is not so significant for the pixel 220 of the n-th row but serves as an operation period for turning on the nMOS switch 524 in the pixel 220 of the (n+1)-th row when the pixel 220 of the n-th row enters the pre-charge operation period.

In the subsequent pre-charge operation period, the nMOS switch 528 is turned off, the nMOS switches 525 and 526 are turned on, the nMOS switch 527 is turned on, and the nMOS switch 522 is turned off. At this point, the nMOS switch 524 in the pixel 220 of the (n+1)-th row is turned on (corresponding to the stand-by operation period) and the nMOS switch 524 in the pixel 220 of the n-th row is turned off.

Thus the voltage of the power supply line 210 is inputted to one end of a holding capacitor 306 through the nMOS switch 524 and the nMOS switches 525 and 526 in the pixel 220 of the (n+1)-th row; meanwhile, the other end of the holding capacitor 306 is fed with a predetermined voltage (e.g., 0 V) that is inputted to the light emission control line 532 when the nMOS switch 522 is turned off. Thus a voltage across the holding capacitor 306 is pre-charged to the voltage of the power supply line 210 and the predetermined voltage (e.g., 0 V) that is inputted to the light emission control Line 532 when the nMOS switch 522 is turned off.

this case, a voltage not higher than the light emission, starting voltage (e.g., 2.5 V) of the organic EL element 301 may be used as the predetermined voltage that is inputted to the light emission control line 532 when the nMOS switch 522 is turned off. Thus it is possible to avoid erroneous light emission of the organic EL element 301 in the pre-charge operation period and improve a contrast ratio, on a display screen.

In the subsequent writing operation period, the nMOS switch 528 is turned on, the nMOS switches 525 and 526 are turned on, the nMOS switch 527 is turned on, and the nMOS switch 522 is turned oft. The nMOS switch 524 in the pixel 220 of the (n+1)-th row is turned off (corresponding to the pre-charge operation period) and the nMOS switch 524 in the pixel 220 of the n-th row is turned off.

Thus a signal voltage written in the signal line 209 is inputted to the source of the drive TFT 523 through the nMOS switch 528. As described above, the drain and gate of the drive TFT 523 are both connected to one end of the holding capacitor 306, which has been pre-charged to the voltage of the power supply line 210, through the nMOS switches 525 and 526. Hence, when a voltage across the holding capacitor 306 decreases to (signal voltage+Vth (the threshold voltage of the drive TFT 523)−(the predetermined voltage inputted to the light emission control line 532 when the nMOS switch 522 is turned off)), the drive TFT is turned off to hold the voltage.

In the subsequent stand-by operation period, the nMOS switch 528 is turned off, the nMOS switches 525 and 526 are turned off, the nMOS switch 527 is turned off, and the nMOS switch 522 is turned on. The nMOS switch 524 in the pixel 220 of the (n+1)-th row is turned off (corresponding to the writing operation period) and the nMOS switch 524 in the pixel 220 of the n-th row is turned on.

Thus the nMOS switch 522 is turned on but the nMOS switch 524 in the pixel 220 of the (n+1)-th row is turned off (corresponding to the writing operation period), so that power is not supplied to the drive TFT 523 and the organic EL element 301 does not emit light.

The second stand-by operation period is not so significant for the pixel 220 but serves as an operation period for turning on the nMOS switch 524 in the pixel 220 of the (n+1)-th row when the pixel 220 of the n-th row enters the pre-charge operation period.

In the subsequent light-on operation period, the nMOS switch 528 is turned off, the nMOS switches 525 and 526 are turned off, the nMOS switch 527 is turned off, and the nMOS switch 522 is turned on. At this point, the nMOS switch 524 in the pixel 220 of the (n+1)-th row is turned on (corresponding to the stand-by operation period) and the nMOS switch 524 in the pixel 220 of the n-th row is also turned on.

Thus the power supply voltage of the power supply line 210 is inputted to the drain of the drive TFT 523 and a voltage held across the holding capacitor 306, that is, (signal voltage+Vth (the threshold voltage of the drive TFT 523)−(the predetermined voltage inputted to the light emission control line 532 when the nMOS switch 522 is turned off)) is inputted between the gate and source of the drive TFT 523. The source of the drive TFT 523 is connected to the organic EL element 301.

Thus the organic EL element 301 emits light with a grayscale Luminance corresponding to a current depending upon the signal voltage written in the holding capacitor. At this point, as in the first embodiment, the organic EL element 301 is not affected by variations in Vth (threshold voltage) of the drive TFT.

The offset voltage of the signal voltage may be adjusted by the predetermined voltage that is inputted to the light emission control line 532 when the nMOS switch 522 is turned off. The light-on operation periods may be sequentially provided over predetermined horizontal scanning periods. In this case, the pixel 220 of the (n+1)-th row also enters the light-on operation period and the nMOS switch 524 in the pixel 220 of the (n+1)-th row is also turned on.

In the subsequent light-off operation period, the nMOS switch 528 is turned off, the nMOS switches 525 and 526 are turned off, the nMOS switch 527 is turned off, and the nMOS switch 522 is turned off. At this point, the nMOS switch 524 in the pixel 220 of the (n+1)-th row is turned on (corresponding to the light-on operation period) and the nMOS switch 524 in the pixel 220 of the n-th row is turned off. Thus the anode of the organic EL element 301 is not connected to the drive TFT 523 and is brought into a floating state, so that the light emission of the organic EL element 301 is stopped.

The light-off operation periods may be sequentially provided over the predetermined horizontal scanning periods if necessary. In this case, the pixel 220 of the (n+1)-th row enters the light-off operation period and the nMOS switch 524 in the pixel 220 of the (n+1)-th row is turned off. However, the emitting state of the organic EL element 301 is not changed.

As described above, the light-off operation periods are provided after the light-on operation periods and the ratio of the periods is optionally controlled. Thus unlike in the display devices 100 of U.S. Pat. No. 6,229,506 and U.S. Patent Application No. 2003/0189335, the luminance of the display device 100 can be optionally adjusted while keeping a dynamic range of luminance. Specifically, for example, the luminance of the display device 100 can be optionally adjusted from 500 (cd/m2) to 5 (cd/m2) while keeping the dynamic range of luminance at one million to one.

The display device 100 may be driven as shown in FIG. 11, in a similar manner to the description of FIG. 6. In this case, the dispersed light-on periods lead to a lower moving image resolution but reduce flicker on the screen. Alternatively, the light-on operation may not be dispersed as illustrated in FIG. 4. The driving methods of FIGS. 4 and 11 are respectively suitable for displaying moving images and static images. Thus the driving methods may be optionally used depending upon the purpose of the display device 100.

As described above, according to the present embodiment, an nMOS having high driving capability can be used for the drive TFT, achieving a large panel having a large number of pixels. Moreover, the characteristics of an nMOS TFT have few dynamic distortions such as a hysteresis, achieving high image quality. Furthermore, the organic EL element may have a cathode electrode structure with higher performance and reliability.

Additionally, it is possible to cancel variations in the threshold voltage of the drive TFT, thereby preventing fixed noise caused by variations in the threshold voltage of the drive TFT from leading to serious image degradation. These effects can be obtained without complicated pixel circuits.

The present invention is not limited to the present embodiment and various modifications can be made. For example, the configuration of the present embodiment can be replaced with substantially the same configuration, a configuration achieving substantially the same effect, or a configuration attaining the same purpose as the configuration of the present embodiment.

### Fourth Embodiment

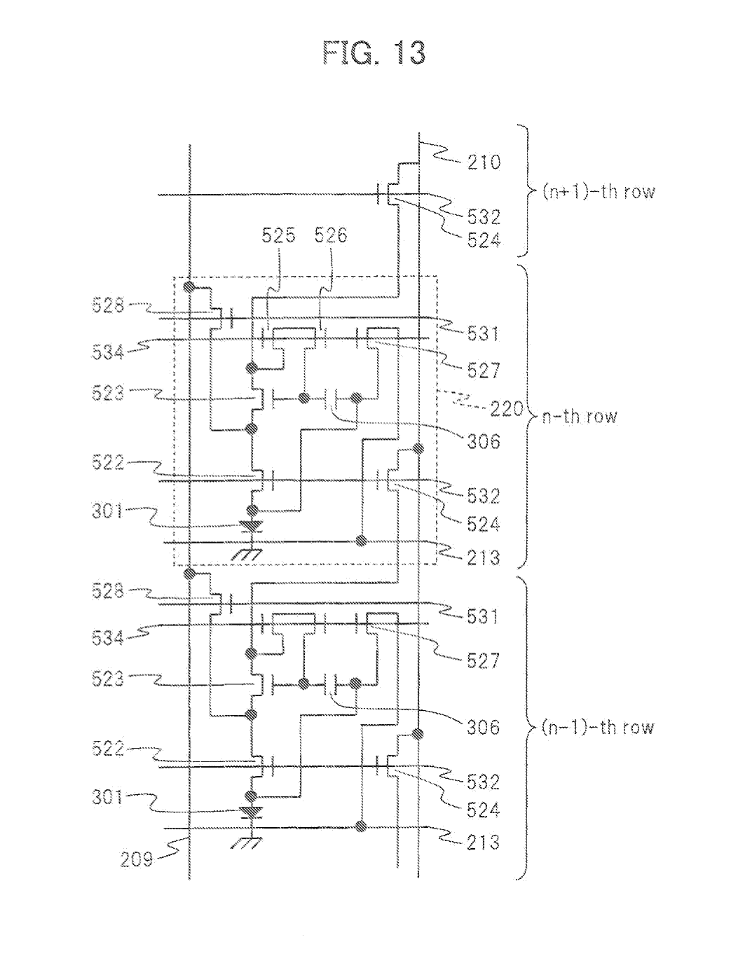

FIG. 13 is an explanatory drawing showing a pixel configuration according to a fourth embodiment. The present embodiment is different from the third embodiment in that one end of an nMOS switch 527 of a pixel 220 is connected to a potential line 213, which is fed with a predetermined voltage, instead of a light emission control line 532. Other points are similar to those of the third embodiment and the explanation thereof is omitted.

Unlike in the third embodiment, the pixel 220 of the present embodiment further requires the potential line 213. Since the potential line 213 is independent from the light emission control line 532, the potential line 213 can have a wide voltage adjustable range. Particularly, in the case where a display signal voltage has a restricted voltage range, a display luminance can be adjusted by the potential line 213. At this point, the potential of the potential line 213 can be more freely optimized without being restricted by conditions for turning off an nMOS switch 522 and an nMOS switch 524.

According to the present embodiment, an nMOS having high driving capability can be used for the drive TFT, achieving a large panel having a large number of pixels. Moreover, the characteristics of an nMOS TFT have few dynamic distortions such as a hysteresis, achieving high image quality. Furthermore, an organic EL element may have a cathode electrode structure with higher performance and reliability.

Additionally, it is possible to cancel variations in the threshold voltage of the drive TFT, thereby preventing fixed noise caused by variations in the threshold voltage of the drive TFT from leading to serious image degradation. These effects can be obtained without complicated pixel circuits.

The present invention is not limited to the present embodiment and various modifications can be made. For example, the configuration of the present embodiment can be replaced with substantially the same configuration, a configuration achieving substantially the same effect, or a configuration attaining the same purpose as the configuration of the present embodiment.

### Fifth Embodiment

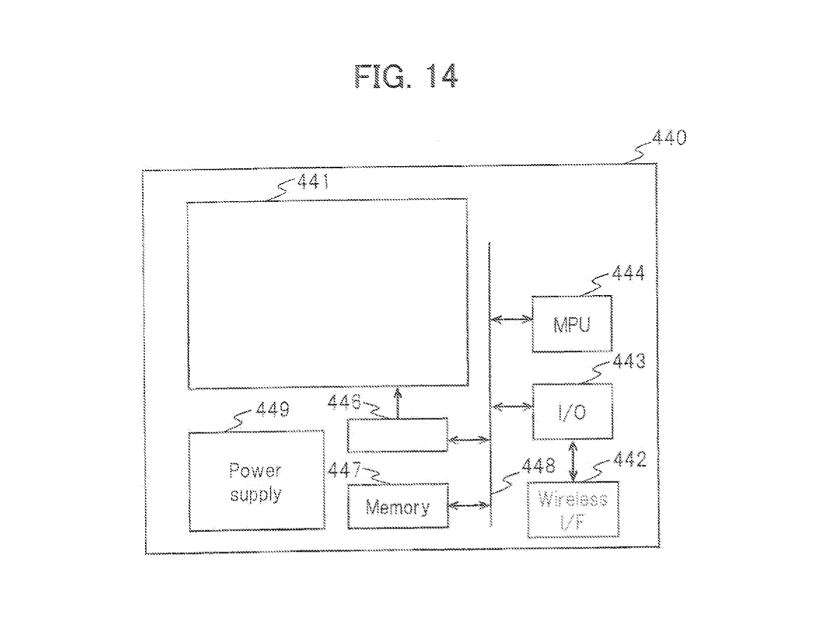

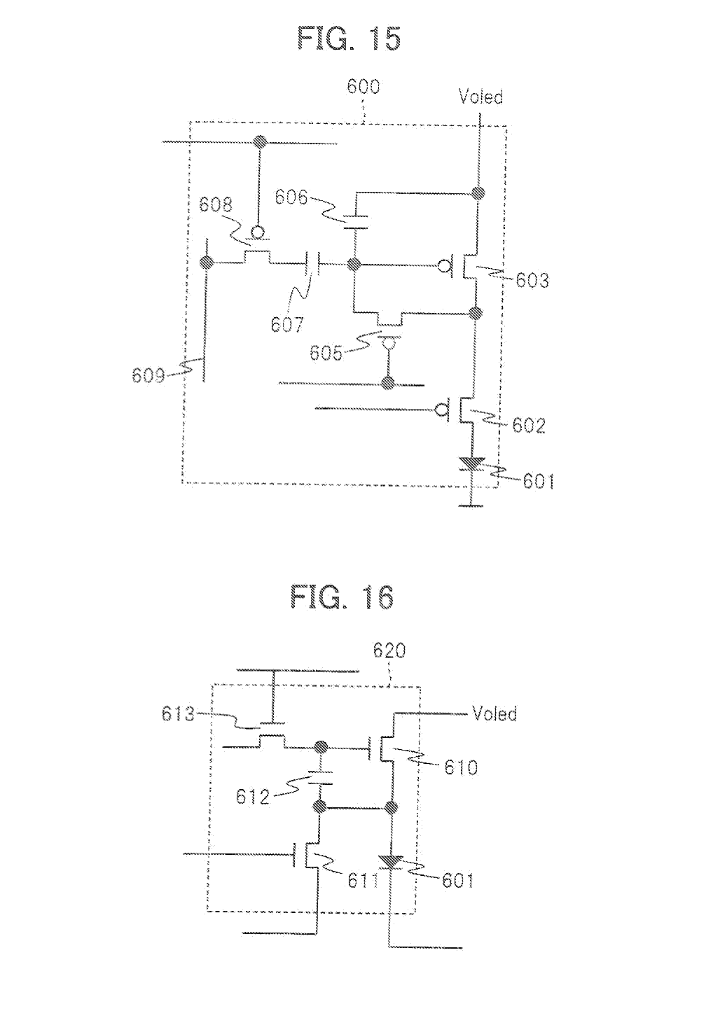

FIG. 14 is an explanatory drawing showing a TV image display device according to a fifth embodiment. As shown in FIG. 14, a TV image display device 440 includes an organic EL display 441. In the present embodiment, the organic EL display 441 corresponds to, for example, the TFT substrate 200 described in the first embodiment.

As shown, in FIG. 14, the TV image display device 440 includes: a power supply 449, a wireless interface (I/F) circuit 442, an input/output (I/O) circuit 443, a microprocessor (MPU) 444, a display device controller 446, and a frame memory 447. The I/O circuit 443, the microprocessor 444, the display device controller 446, and the frame memory 447 are connected to a data bus 448.

The wireless interface (I/F) circuit 442 receives terrestrial digital signals. Specifically, for example, the wireless interface (I/F) circuit 442 receives compressed image data as wireless data from the outside. Furthermore, the wireless interface (I/F) circuit 442 outputs the compressed image data to the data bus 448 through the input/output (I/O) circuit 443.

The display device controller 446 is connected to the organic EL display 441. The power supply 449 has, for example, a secondary battery that supplies power for driving the overall TV image display device 440.

The following will describe the operations of the TV image display device 440 according to the present embodiment. First, the wireless I/F circuit 442 captures compressed image data from the outside in response to a command, and transfers the image data to the microprocessor 444 and the frame memory 447 through the I/O circuit 443.

The microprocessor 444 receives an instruction from a user and optionally drives the overall TV image display device 440 to decode the compressed image data, perform signal processing, and display information. The image data having been subjected to signal processing may be temporarily stored in the frame memory 447.

In the case where the microprocessor 444 issues a display instruction, the image data is inputted from the frame memory 447 to the organic EL display 441 through the display device controller 446 in response to the instruction, and the organic EL display 441 displays the inputted image data in real time.

At this point, the display device controller 446 outputs and controls a predetermined timing pulse for image display. The organic EL display 441 displays the inputted image data in real time by using these signals. The real-time display of the image data has been described in, for example, the first embodiment and thus the explanation thereof is omitted.

According to the present embodiment, an nMOS having high driving capability can be used for a drive TFT, achieving a large panel having a large number of pixels. Moreover, the characteristics of an nMOS TFT have few dynamic distortions such as a hysteresis, achieving high image quality. Furthermore, an organic EL element may have a cathode electrode structure with higher performance and reliability.

Additionally, it is possible to cancel variations in the threshold voltage of the drive TFT, thereby preventing fixed noise caused by variations in the threshold voltage of the drive TFT from leading to serious image degradation. These effects can be obtained without complicated pixel circuits.

In the present embodiment, the TFT substrate 200 of the first embodiment is used as the organic EL display 441. As a matter of course, the TFT substrates 200 of other embodiments may be used. In this case, a timing pulse outputted by the display device controller 446 has to be changed to some extent.

The present invention is not limited to the first to fifth embodiments and various modifications can be made. For example, the configurations of the first to fifth embodiments can be replaced with substantially the same configuration, a configuration achieving substantially the same effect, or a configuration attaining the same purpose as the configurations of the first to fifth embodiments.

For example, the pixel configurations of the foregoing embodiments are merely exemplary and are not particularly limited. The pixel configurations can be replaced with substantially the same configuration, a configuration achieving substantially the same effect, or a configuration attaining the same purpose as the pixel configurations.

In the above explanation, the light emitting elements include, but are not limited to, the organic EL elements. The image display devices according to the embodiments of the present invention may include various light emitting elements such as an inorganic EL element and a field-emission device (FED).

What is claimed is:

1. A display device comprising:
a plurality of pixels arranged in a matrix, each of the pixels having a light emitting element;
a signal line that supplies a video signal voltage to each of the pixels according to a gray scale value;
a power supply line that supplies light emission cower to each of the light emitting elements; and
a predetermined voltage supply line that supplies a predetermined voltage to each of the pixels,
wherein each of the pixels includes:
a field-effect transistor that controls a drive current of the light emitting element;
a first switch provided between a source of the field-effect transistor and an anode terminal of the light emitting element;
a second switch provided between the source of the field-effect transistor and the signal line;
a third switch provided between a drain of the field-effect transistor and the power supply line;
a fourth switch provided between the drain and a gate of the field-effect transistor;
a capacitor provided between the gate of the field-effect transistor and the anode terminal of the light emitting element; and
a fifth switch provided between the anode terminal of the light emitting element and the predetermined voltage supply line.

2. The display device according to claim 1, wherein the field-effect transistor is an nMOS transistor.

3. The display device according to claim 1, wherein the first to fifth switches are nMOS transistors or pMOS transistors.

4. The display device according to claim 3, wherein the first to fifth switches are all nMOS transistors.

5. The display device according to claim 1, wherein the second switch and the third switch are connected to a common scanning line.

6. The display device according to claim 1, wherein the first switch and the fifth switch are connected to a common scanning line.

7. The display device according to claim 1, wherein the first switch, the fifth switch, and the fourth switch are connected to a common scanning line.

8. The display device according to claim 1, wherein the first switch and a third switch included in the adjacent pixel are connected to a common scanning line.

9. The display device according to claim 1, wherein the fifth switch and the forth switch are connected to a common scanning line.

10. The display device according to claim 1, wherein the predetermined voltage supply line is a scanning line of the first switch.

11. The display device according to claim 1, wherein the light emitting element is an organic light emitting diode.

12. The display device according to claim 1, wherein the field-effect transistor is a TFT.

13. The display device according to claim 12, wherein the TFT is a polycrystalline Si semiconductor device.

14. The display device according to claim 12, wherein the TFT is a microcrystalline Si semiconductor device.

15. The display device according to claim 12, wherein the TFT is an amorphous semiconductor device.

16. The display device according to claim 12, wherein the TFT is an oxide semiconductor device.
